(19) United States
(12) Patent Application Publication
(10) Pub. No.: US 2005/0229488 A1
(43) Pub. Date: Oct. 20, 2005

(54) Method and apparatus for providing a continuous stream of reformate

(75) Inventor: James F. Stevens, Katy, TX (US)

Correspondence Address: FRANK C. TURNER;CHEVRON SERVICES COMPANY, LAW DEPARTMENT, P.O. BOX 3725, HOUSTON, TX, 77253-3725, US

(73) Assignees: TEXACO INC., San Ramon, CA (US); TEXACO DEVELOPMENT CORPORATION, San Ramon, CA (US)

(21) Appl. No.: 10/827,148

(22) Filed: Apr. 19, 2004

(51) Int. Cl. B01J 8/00

(52) U.S. Cl. 48/198.7; 48/127.9; 48/128; 48/198.3

(57) ABSTRACT

Method and apparatus for converting hydrocarbon fuels to hydrogen-rich reformate that incorporate a carbon dioxide fixing mechanism into the initial hydrocarbon conversion process and for providing a continuous supply of hydrogen-rich reformate. The apparatus includes a reforming reactor that has a catalyst bed comprising a reforming catalyst, a carbon dioxide fixing material and an optional water gas shift catalyst; a hydrogen storage device for storing reformate; and a controller for controlling the delivery of reformate from the reactor and/or storage device to an outlet. Optionally, the apparatus can include a heating device for heating the catalyst bed and a polishing unit for removing impurities from the reformate. The reforming reactor is operable in reforming and non-reforming modes. During non-reforming modes, the hydrogen storage device provides reformate to the outlet so as to maintain a continuous supply of reformate. A method for providing a continuous supply of hydrogen-rich reformate for use in a hydrogen-consuming device or process is also provided.

### FIELD OF THE INVENTION

The present invention relates to the field of fuel processing wherein hydrocarbon-based fuels are converted into a hydrogen-enriched reformate for ultimate use in hydrogen-consuming devices and processes. The apparatus and methods of the instant invention provide a hydrogen-rich reformate of high purity by utilizing absorption enhanced reforming wherein a by-product, such as carbon dioxide, is absorbed from the product stream to shift the conversion reaction equilibrium toward higher hydrocarbon conversion with smaller amounts of by-products produced.

### BACKGROUND OF THE INVENTION

Hydrogen is utilized in a wide variety of industries ranging from aerospace to food production to oil and gas production and refining. Hydrogen is used in these industries as a propellant, an atmosphere, a carrier gas, a diluent gas, a fuel component for combustion reactions, a fuel for fuel cells, as well as a reducing agent in numerous chemical reactions and processes. In addition, hydrogen is being considered as an alternative fuel for power generation because it is renewable, abundant, efficient, and unlike other alternatives, produces zero emissions. While there is wide-spread consumption of hydrogen, and great potential for even more, a disadvantage which inhibits further increases in hydrogen consumption is the absence of a hydrogen infrastructure to provide widespread generation, storage and distribution. One way to overcome this difficulty is through distributed generation of hydrogen, such as through the use of fuel reformers to convert a hydrocarbon-based fuel to a hydrogen-rich reformate.

Fuel reforming processes, such as steam reforming, partial oxidation, and autothermal reforming, can be used to convert hydrocarbon fuels such as natural gas, LPG, gasoline, and diesel, into hydrogen-rich reformate at the site where the hydrogen is needed. However, in addition to the desired hydrogen product, fuel reformers typically produce undesirable impurities that reduce the value of the reformate product. For instance, in a conventional steam reforming process, a hydrocarbon feed, such as methane, natural gas, propane, gasoline, naphtha, or diesel, is vaporized, mixed with steam, and passed over a steam reforming catalyst. The majority of the feed hydrocarbon is converted to a mixture of hydrogen and impurities such as carbon monoxide and carbon dioxide. The reformed product gas is typically fed to a water-gas shift bed in which the carbon monoxide is reacted with steam to form carbon dioxide and hydrogen. After the shift step, additional purification steps are required to bring the hydrogen purity to acceptable levels. These steps can include, but are not limited to, methanation, selective oxidation reactions, passing the product stream through membrane separators, and/or pressure swing absorption processes. While such purification technologies may be known, the added cost and complexity of integrating them with a fuel reformer to produce a sufficiently pure hydrogen reformate can render their construction and operation impractical.

In terms of power generation, fuel cells typically employ hydrogen as fuel and oxygen as an oxidizing agent in catalytic oxidation-reduction reactions to produce electricity. As with most industrial applications utilizing hydrogen, the purity of the hydrogen used in fuel cell systems is critical. Specifically, because power generation in fuel cells is proportional to the consumption rate of the reactants both their efficiency and cost can be improved through the use of a high purity hydrogen reformate. Moreover, the catalysts employed in many types of fuel cells can be deactivated or permanently impaired by exposure to certain impurities. For use in a PEM fuel cell, hydrogen reformate should contain very low levels of carbon monoxide (<50 ppm) so as to prevent carbon monoxide poisoning of the catalysts. In the case of alkaline fuel cells, hydrogen reformate should contain low levels of carbon dioxide so as to prevent the formation of carbonate salts on the electrodes. As a result, an improved yet simplified reforming apparatus and methods capable of providing a high purity hydrogen reformate that is low in carbon oxides are greatly desired.

The disclosure of U.S. Pat. No. 6,682,838, issued to Stevens, Jan. 27, 2004, is incorporated herein by reference.

### SUMMARY OF THE INVENTION

In one aspect of the instant invention, a fuel supply apparatus for providing a continuous supply of a hydrogen-rich reformate is provided. A fuel supply apparatus of the instant invention includes a reforming reactor having a catalyst bed for converting a hydrocarbon fuel to a reformate. The apparatus further includes a hydrogen storage device that is in fluid communication with the reforming reactor for storing at least a portion of the reformate, and a reformate outlet in fluid communication with the hydrogen storage device. A controller is provided that is in communication with the reforming reactor and the hydrogen storage device for controlling the delivery of reformate to the reformate outlet. In some embodiments, the controller optionally controls the operations of the reforming reactor and the hydrogen storage device, and further can control the delivery of reformate to the reformate outlet at a selected rate.

In some embodiments, the reforming reactor is operable in a non-reforming mode. Non-reforming modes can include one or more operations selected from the group consisting of cooling the catalyst bed to a reforming temperature, heating the catalyst bed to a reforming temperature, heating the catalyst bed to a calcination temperature, hydrating the catalyst bed with steam, adjusting a flow of hydrocarbon fuel to the catalyst bed and/or adjusting a flow of steam to the catalyst bed. A plurality of catalyst beds can be disposed within the reforming reactor, but in preferred embodiments, the reforming reactor includes a single catalyst bed. The catalyst bed includes a reforming catalyst, a carbon dioxide fixing material, and an optional water gas shift catalyst. The catalyst(s) and the carbon dioxide fixing material can have a uniform distribution within the catalyst bed, but in some embodiments will have a non-uniform distribution.

Optionally, the apparatus of the instant invention will further include heat generating means that are operably connected to the reforming reactor for heating the catalyst bed to a calcination temperature. In addition, the apparatus can optionally include a polishing unit disposed downstream from the catalyst bed for removing one or more impurities from the hydrogen-rich reformate. Suitable polishing units can include drying units, methanation reactors, selective oxidation reactors, pressure swing absorption units, temperature swing absorption units, membrane separation units and combinations of the same.

Hydrogen storage devices suitable for use in the apparatus of the instant invention can include a compressor for compressing the reformate and a high pressure storage vessel in communication with the compressor for storing a pressurized reformate. In other embodiments, the hydrogen storage device can include a storage vessel and a hydrogen fixing material disposed within the storage vessel. Suitable hydrogen fixing materials can include activated carbon, carbon composites, fullerene based materials, metal hydrides, alloys comprising titanium, vanadium, chromium and manganese, and nanostructures formed from elements of the second and/or third rows of the periodic table. In still other embodiments, the hydrogen storage device can include a liquefaction unit for converting a hydrogen-rich reformate to a liquefied reformate and a storage vessel for storing the liquefied reformate. Suitable hydrogen storage devices can have storage capacity sufficient for delivering reformate to the reformate outlet at a selected rate while the reforming reactor is operated in a non-reforming mode.

In another embodiment, the instant invention can include a manifold in fluid communication with each of the reforming reactor, the hydrogen storage device and the reformate outlet. The manifold can be disposed downstream of the reforming reactor and is capable of directing hydrogen-rich reformate to the hydrogen storage device and/or the reformate outlet. In such an embodiment, the controller preferably controls the manifold and the delivery of hydrogen-rich reformate and/or stored reformate to the reformate outlet.

An apparatus of the instant invention can optionally include a hydrogen-consuming device in fluid communication with the reformate outlet disposed downstream of the reformate outlet. In such an embodiment, it is preferred that the controller communicate with the hydrogen-consuming device.

In another aspect of the instant invention, a method for providing a continuous supply of hydrogen-rich reformate for use in a hydrogen-consuming device or process is provided. The method includes the step of reforming a hydrocarbon fuel within a catalyst bed that comprises a reforming catalyst and a carbon dioxide fixing material to produce a reformate product comprising hydrogen and carbon dioxide. The carbon dioxide fixing material within the catalyst bed fixes at least a portion of the carbon dioxide in the reformate product to produce a hydrogen-rich reformate. The method further includes the step of storing at least a portion of the hydrogen-rich reformate in a hydrogen storage device to provide a stored reformate. In addition, the method includes the step of controlling the hydrogen-rich reformate and/or stored reformate that is delivered to a reformate outlet.

Optionally, the methods of the instant invention can include the additional steps of heating the catalyst bed to a calcination temperature prior to reforming the hydrocarbon fuel and allowing the heated bed to cool to a reforming temperature or hydrating the heated catalyst bed with steam. The methods can also optionally include heating the catalyst bed to a reforming temperature prior to reforming the hydrocarbon fuel and polishing the hydrogen-rich reformate to remove one or more impurities. This optional polishing step can be selected from the group consisting of drying, methanation, selective oxidation, pressure swing adsorption, temperature swing adsorption, and membrane separation.

In some embodiments, the methods can include the steps of interrupting the reforming of the hydrocarbon fuel in the catalyst bed, heating the catalyst bed to a calcination temperature to release fixed carbon dioxide, and directing the carbon dioxide-laden gas out of the catalyst bed. In embodiments where a carbon dioxide-laden gas has been directed from the catalyst bed, the catalyst bed is allowed to cool to a reforming temperature before resuming the reforming of the hydrocarbon fuel. In other embodiments where a carbon dioxide-laden gas has been directed from the catalyst bed, the catalyst bed is hydrated with steam before resuming the reforming of the hydrocarbon fuel. Where the catalyst bed is hydrated with steam, the method can further include the step of heating the catalyst bed to a reforming temperature prior to resuming the reforming of the hydrocarbon fuel.

In another embodiment, the method of the instant invention can further include the step of selecting a rate at which hydrogen-rich reformate and/or stored reformate is to be delivered to the reformate outlet. In such an embodiment, the rate at which hydrogen-rich reformate and/or stored reformate is to be delivered to the reformate outlet can be selected at least in part based on a reformate requirement of a hydrogen-consuming device in fluid communication with the reformate outlet. When the reforming reactor is operated in a non-reforming mode such that the catalyst bed is not producing hydrogen-rich reformate, stored reformate is delivered to the reformate outlet in order to deliver a continuous supply of reformate at the selected rate.

### BRIEF DESCRIPTION OF THE DRAWINGS

The invention may be understood by reference to the following description taken in conjunction with the accompanying drawings.

FIG. 1 is a schematic diagram of an apparatus of the instant invention.

FIG. 2 is a schematic diagram of an apparatus of the instant invention.

FIG. 3 is a schematic diagram of an apparatus of the instant invention.

FIG. 4 is a flow diagram illustrating a method of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

The instant invention is generally directed to a method and apparatus for converting hydrocarbon-based fuel to a hydrogen-rich reformate. The instant invention simplifies the production of a highly pure hydrogen-rich reformate by incorporating a carbon dioxide fixing mechanism into the initial hydrocarbon conversion process. The mechanism utilizes a carbon dioxide fixing material within the reforming catalyst bed that can be any substance capable of reacting with carbon dioxide and/or retaining carbon dioxide at a temperature within the range of temperatures that is typical of hydrocarbon conversion to hydrogen and carbon oxides. Hydrocarbon to hydrogen conversion reactions utilizing such carbon dioxide fixing materials are referred to generally as “absorption enhanced reforming” as the absorption or removal of carbon dioxide from the reformed product shifts the reforming reaction equilibrium toward higher hydrocarbon conversion with smaller amounts of carbon monoxide and carbon dioxide being produced.

Carbon dioxide fixing materials are typically caused to desorb or release carbon dioxide by application of a change in temperature, pressure or a combination of changes in temperature and pressure. However, where the carbon dioxide fixing materials are embedded within the reforming catalyst bed, operations to release fixed carbon dioxide generally require interruption of the reforming reaction and thus interruption of the production of hydrogen-rich reformate. As a result, there is a need for a fuel supply apparatus and method that will enable the delivery of a continuous supply of hydrogen-rich reformate from a reforming reactor that cycles between reforming mode and one or more non-reforming modes during normal operation.

As summarized above, a fuel supply apparatus of the instant invention comprises a reforming reactor having a catalyst bed that comprises a reforming catalyst and a carbon dioxide fixing material for converting a hydrocarbon fuel to a reformate.

Reactors suitable for use in the apparatus and methods of the instant invention comprise a reactor vessel having an inlet for receiving a hydrocarbon fuel and an outlet for delivering a hydrogen-rich reformate. The inlet of the reactor vessel is preferably connected to sources of hydrocarbon fuel and steam. Optionally, where a hydrocarbon fuel to be utilized in the reactor vessel comprises sulfur-containing compounds, a desulfurization unit can be connected to the vessel to reduce the sulfur content of the fuel. A source of air, oxygen, or oxygen-enriched air can be connected to the reactor vessel, such as where the intended reforming reaction is an autothermal reforming reaction. Separate inlets for hydrocarbon fuel(s), steam, and/or air may be utilized, or in an alternative, two or more of such materials may be combined and mixed outside the reactor vessel and introduced as a mixture through a common inlet.

Reactor vessels and other process equipment described herein may be fabricated from any material capable of withstanding the operating conditions and chemical environment of the reactions described, and can include, for example, carbon steel, stainless steel, Inconel, Incoloy, Hastelloy, and the like. The operating pressure for the reactor vessel and other process units are preferably from about 0 to about 100 psig, although higher pressures may be employed. Ultimately, the operating pressure of the fuel processor depends upon the delivery pressure required of the hydrogen produced. Where the hydrogen is to be delivered to a fuel cell operating in the 1 to 20 kW range, an operating pressure of 0 to about 100 psig is generally sufficient. Higher pressure conditions may be required depending on the hydrogen requirements of the end user. As described herein, the operating temperatures within the reactor vessel will vary depending on the type reforming reaction, the type of reforming catalyst, the carbon dioxide fixing material, the water gas shift catalyst when used, and selected pressure conditions amongst other variables.

The apparatus and methods of the instant invention generate a hydrogen-rich reformate utilizing multiple reactions within a common catalyst bed. Typical reactions that may be performed within the catalyst bed include fuel reforming reactions such as steam and/or autothermal reforming reactions that generate a reformate containing hydrogen, carbon oxides and potentially other impurities, water gas shift reactions wherein water and carbon monoxide are converted to hydrogen and carbon dioxide, and carbonation reactions wherein carbon dioxide is physically absorbed or chemically converted to preferably a non-gaseous species. Chemical equations for such a combination of reactions using methane as the hydrocarbon fuel and calcium oxide as the carbon dioxide fixing material are as follows:

| | | |
|---|---|---|
| CH₄ + H₂O → 3H₂ + CO | (Steam Reforming) | (I) |
| H₂O + CO → H₂ + CO₂ | (Water Gas Shift) | (II) |
| CO₂ + CaO → CaCO₃ | (Carbonation) | (III) |
| CH₄ + 2H₂O + CaO → 4H₂ + CaCO₃ | (Combined) | (IV) |

While these equations exemplify the conversion of methane to a hydrogen-rich reformate, the scope of the invention should not be construed to be so limited. As used herein the term “hydrocarbon fuel” includes organic compounds having C—H bonds which are capable of producing hydrogen from a partial oxidation, autothermal and/or a steam reforming reaction. The presence of atoms other than carbon and hydrogen in the molecular structure of the compound is not excluded. Thus, suitable fuels for use in the method and apparatus disclosed herein can include, but are not limited to, hydrocarbon fuels such as natural gas, methane, ethane, propane, butane, naphtha, gasoline, diesel and mixtures thereof, and alcohols such as methanol, ethanol, propanol, and mixtures thereof. Preferably, the hydrocarbon fuel will be a gas at 30° C., standard pressure. More preferably the hydrocarbon fuel will comprise a component selected from the group consisting of methane, ethane, propane, butane, and mixtures of the same.

A source of water will also be operably connected to the catalyst bed(s). Water can be introduced to the catalyst bed as a liquid or vapor, but is preferably steam. The ratios of the reaction feeds are determined by the desired operating conditions as they can affect both operating temperature and yield. In embodiments where the reforming reaction utilizes a steam reforming catalyst, the steam to carbon ratio is in the range between about 8:1 to about 1:1, preferably between about 5:1 to about 1.5:1 and more preferably between about 4:1 to about 2:1. When the catalyst bed is being operated in a non-reforming mode, such as when the carbon dioxide fixing material is being heated to a calcination temperature, the flow of steam to the bed will be reduced and in some embodiments interrupted. In addition, it should also be noted that steam temperatures can be varied depending on the mode of operation. For example, steam that is used to hydrate the carbon dioxide fixing material will typically be at a lower temperature than steam that is used for reforming the hydrocarbon fuel.

The apparatus and methods of the instant invention utilize a common catalyst bed that comprises a reforming catalyst, preferably a steam reforming catalyst with or without a separate water gas shift catalyst, and a carbon dioxide fixing material. Suitable catalysts can serve multiple functions such as catalyzing a reforming reaction of hydrocarbon fuel with steam to give a reformats mixture of hydrogen, carbon monoxide, and carbon dioxide, and/or a shift reaction between water and carbon monoxide to form hydrogen and carbon dioxide. The carbon dioxide fixing material is utilized to remove carbon dioxide from the reformate product and thereby shifting the reforming reaction equilibrium toward the production of higher concentrations of hydrogen with lower concentrations of carbon oxides.

The reforming catalyst(s) may be in any form including pellets, spheres, extrudates, monoliths, as well as common particulates and agglomerates. Conventional steam reforming catalysts are well known in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium. Where the reforming reaction is preferably a steam reforming reaction, the reforming catalyst preferably comprises rhodium on an alumina support. Suitable reforming catalysts are commercially available from companies such as Cabot Superior Micropowders LLC (Albuquerque, N. Mex.) and Engelhard Corporation (Iselin, N.J.).

Certain reforming catalysts have been found to exhibit activity for both reforming and water gas shift reactions. In particular, it has been found that a rhodium catalyst on alumina support will catalyze both a steam methane reforming reaction and a water gas shift reaction under the conditions present in the catalyst bed. In such circumstances, the use of a separate water gas shift catalyst is not required. Where the selected reforming catalyst does not catalyze the shift reaction, the catalyst bed comprises a separate water gas shift catalyst.

Reaction temperatures of an autothermal reforming reaction can range from about 550° C. to about 900° C. depending on the feed conditions and the catalyst. In a preferred embodiment, the reforming reaction is a steam reforming reaction with a reforming temperature in the range from about 400° C. to about 800° C., preferably in the range from about 450° C. to about 700° C., and more preferably in the range from about 500° C. to about 650° C. Reaction temperatures can be achieved by flowing gas(es) such as heated streams of helium, nitrogen, steam, as well as heated exhaust gases from a fuel cell or the tail gas of a metal hydride storage system through the catalyst bed. In an alternative, heat exchanging means for removing heat from and/or delivering heat to the catalyst bed can also optionally be incorporated into the catalyst bed, catalyst bed support means or simply imbedded amongst catalyst bed components. Suitable heat exchanging means will be capable of raising the bed temperature to a reforming temperature and/or to a calcination temperature depending on the operational mode of the reactor. Further, heat from the heat exchanging means can also used to pre-heat reactant feeds to the catalyst bed(s).

Suitable heat exchanging means can include means capable of generating heat such as electrically resistant heating coils that are embedded within the catalyst bed. Alternatively, heat exchanging means can comprise heat transfer devices within the catalyst bed that are operably coupled with separate heat generating means. Suitable heat generating means can include conventional heating units such as resistant heating coils, burners or combustors, and fuel cell and/or hydrogen storage system that produce heated exhaust gases. For instance, in a preferred embodiment, the heat exchanging means comprise a heat exchanger coil or heat pipe operably coupled to heat generating means that is capable of providing variable heat so that the amount of heat delivered to the catalyst bed can be adjusted to achieve the appropriate reforming or calcination temperature.

In some embodiments, two or more heat generating means can be used to provide heat within different temperature ranges. More specifically, one heat generating means generates heat for heating the catalyst bed to a reforming reaction temperature and a second heat generating means generates heat for heating a catalyst bed to a calcinating temperature. Where two or more reforming catalyst beds are utilized such that one bed is in reforming mode while simultaneously a second bed is heated to a calcination temperature, it is preferred that the two heat generating means be thermally integrated so as to improve the thermal efficiency of the apparatus. Thermal integration can be achieved by pre-heating reforming reactant feeds such as hydrocarbon fuel and steam with the excess heat that is generated for heating the second catalyst bed to a calcination temperature. Where the heat generating means comprise a burner or combustor, oxidant(s) to be reacted in the heat generating means can likewise be pre-heated to improve thermal efficiency.

The heating of the catalyst bed for the reforming reaction and/or calcination reaction can be achieved by providing a continuous supply of heat to the bed that is sufficient to achieve and maintain the desired temperature throughout the reaction. In an alternative, the bed may initially be heated to the desired reaction temperature with heating thereafter discontinued as the reaction proceeds. In such an embodiment, the bed temperature is monitored and additional heat provided if needed to maintain a desired reaction temperature.

In some embodiments, the instant invention will include a water gas shift catalyst within the catalyst bed to convert steam and carbon monoxide to hydrogen and carbon dioxide. Providing a water gas shift reaction within the catalyst bed can be beneficial because carbon monoxide, in addition to being highly toxic to humans, is a poison to many fuel cell catalysts. The maximum level of carbon monoxide in the hydrogen-rich reformate should be a level that can be tolerated by fuel cells, typically below about 50 ppm. In addition, there is growing demand for higher purity reformate streams that have carbon monoxide concentrations below about 25 ppm, preferably below about 15 ppm, more preferably below 10 ppm, and still more preferably below about 5 ppm.

Water gas shift reactions generally occur at temperatures of from about 150° C. to about 600° C. depending on the catalyst used. Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like. Higher temperature shift catalysts are preferably operated at temperatures ranging from about 300° C. to about 600° C. and can include transition metal oxides such as ferric oxide or chromic oxide, and optionally include a promoter such as copper or iron silicide. Suitable high temperature shift catalysts also include supported noble metals such as supported platinum, palladium and/or other platinum group members. Suitable water gas shift catalysts are commercially available from companies such as Cabot Superior Micropowders LLC (Albuquerque, N. Mex.) and Engelhard Corporation (Iselin, N.J.).

The catalyst bed will also include a carbon dioxide fixing material. As used in this disclosure, “carbon dioxide fixing material” is intended to refer to materials and substances that react or bind with carbon dioxide at a temperature within the range of temperatures that is typical of hydrocarbon conversion to hydrogen and carbon oxides. Such carbon dioxide fixing materials include, but are not limited to, those materials that will adsorb or absorb carbon dioxide as well as materials that will convert carbon dioxide to a chemical species that is more easily removed from the reformate gas stream. In addition, suitable fixing materials will need to be stable in the presence of steam at reforming temperatures, can maintain a high carbon dioxide fixing capacity over multiple reforming/calcination cycles, are low in toxicity and pyrophoricity, and will preferably be low in cost.

Suitable carbon dioxide fixing materials can comprise an alkaline earth oxide(s), a doped alkaline earth oxide(s) or mixtures thereof. Preferably, the carbon dioxide fixing material will comprise calcium, strontium, or magnesium salts combined with binding materials such as silicates or clays that prevent the carbon dioxide fixing material from becoming entrained in the gas stream and reduce crystallization that decreases surface area and carbon dioxide absorption. Salts used to make the initial bed can be any salt, such as an oxide or hydroxide that will convert to the carbonate under process conditions. Specific substances that are capable of fixing carbon dioxide in suitable temperature ranges include, but are not limited to, calcium oxide (CaO), calcium hydroxide (Ca(OH)₂), strontium oxide (SrO), strontium hydroxide (Sr(OH)₂) and mixtures thereof.

Other suitable carbon dioxide fixing materials can include those materials described in U.S. Pat. No. 3,627,478 issued Dec. 14, 1971 to Tepper, (describing the use of weak base ion exchange resins at high pressure to absorb CO₂); U.S. Pat. No. 6,103,143 issued Aug. 15, 2000 to Sircar et al., (describing a preference for the use of modified double layered hydroxides represented by the formula [Mg₍₁₋ₓ₎Alₓ(OH)₂] [CO₃]_{x/2yH2}O.zM′₂CO₃ where 0.09≦x≦0.40, 0≦y≦3.5, 0≦z≦3.5 and M′=Na or K, and spinels and modified spinels represented by the formula Mg[Al₂]O₄.yK₂CO₃ where 0≦y≦3.5); U.S. patent application Publication No. 2002/0110503 A1 published Aug. 15, 2002 by Gittleman et al., (describing the use of metal and mixed metal oxides of magnesium, calcium, manganese, and lanthanum and the clay minerals such as dolomite and sepiolite); and U.S. patent application Publication No. 2003/0150163 A1 published Aug. 14, 2003 by Murata et al., (describing the use of lithium-based compounds such as lithium zirconate, lithium ferrite, lithium silicate, and composites of such lithium compounds with alkaline metal carbonates and/or alkaline earth metal carbonates); the disclosures of each of which are incorporated herein by reference. In addition, suitable mineral compounds such as allanite, andralite, ankerite, anorthite, aragoniter, calcite, dolomite, clinozoisite, huntite, hydrotalcite, lawsonite, meionite, strontianite, vaterite, jutnohorite, minrecordite, benstonite, olekminskite, nyerereite, natrofairchildite, farichildite, zemkorite, butschlite, shrtite, remondite, petersenite, calcioburbankite, burbankite, khanneshite, carboncernaite, brinkite, pryrauite, strontio dressenite, and similar such compounds and mixtures thereof, can be suitable materials for fixing carbon dioxide.

One or more of the described carbon dioxide fixing materials may be preferred depending on such variables as the hydrocarbon fuel to be reformed, the selected reforming reaction conditions and the specification of the hydrogen-rich gas to be produced. In addition, the fixing material selected should exhibit low equilibrium partial pressure of carbon dioxide in the temperature range of about 400° C. to about 650° C. and high equilibrium partial pressure of carbon dioxide at temperatures from about 150° C. to about 400° C. above the selected reforming reaction temperature.

The carbon dioxide fixing material may take any of the forms suggested above for catalysts, including pellets, spheres, extrudates, monoliths, as well as common particulates and agglomerates. In addition, the catalyst(s) and carbon dioxide fixing material may be combined into a mixture in one or more of these forms. In a preferred embodiment, the carbon dioxide fixing material will be combined with catalyst(s) to form a mixture that is processed into a particulate using an aerosol method such as is disclosed in U.S. Pat. No. 6,685,762 issued Feb. 3, 2004, to Brewster et al., the contents of which are incorporated herein by reference.

The apparatus and methods of the present invention produce an improved hydrogen-rich reformate because the carbon dioxide fixing material reacts with or “fixes” carbon dioxide within the reforming catalyst bed, thereby removing it from the reformate product and shifting the reforming reaction equilibrium toward the production of increased molar amounts of hydrogen. Where the carbon dioxide fixing material is calcium oxide, the fixing reaction is a carbonation reaction that produces calcium carbonate as shown in Equation III above.

Although conventional catalyst beds having multiple components tend to have a uniform distribution of components along the reactants' pathway through the bed, it has been found that superior conversion rates can be achieved with absorption enhanced reforming where the catalyst(s) and carbon dioxide fixing materials have a non-uniform distribution within the bed. Generally, the catalyst composition nearest the bed inlet should contain an amount of reforming catalyst that is greater than the average level of reforming catalyst across the bed. In contrast, the composition nearest the bed outlet should contain an amount of reforming catalyst that is less than the average level of reforming catalyst across the bed. In a preferred embodiment, the non-uniform distribution will provide no reforming catalyst proximate the bed outlet as there would be little opportunity for carbon dioxide produced by a reforming reaction at such a location to be fixed before the reformate product exits the bed.

In some embodiments, a non-uniform distribution of reforming catalyst can be achieved by providing a generally smooth distribution of reforming catalyst that decreases across the bed from the inlet to the outlet. In other embodiments, a non-uniform distribution of reforming catalyst can be achieved by providing a plurality of reaction zones that have generally decreasing concentrations of reforming catalyst ranging from the inlet to the outlet. A more specific example of a zoned approach is to provide a catalyst bed with a plurality of reaction zones that include an inlet zone located proximate the bed inlet, an outlet zone located proximate the bed outlet, and one or more optional intermediate zones disposed between the inlet and outlet zones. In such embodiments, the inlet zone comprises reforming catalyst, an optional water gas shift catalyst, but preferably no carbon dioxide fixing material. Further, the outlet zone comprises carbon dioxide fixing material and an optional but highly preferred water gas shift catalyst, but no reforming catalyst. A more detailed description of a catalyst beds having a non-uniform distribution of bed components may be found in U.S. patent application “Reactor with Carbon Dioxide Fixing Material,” Stevens, et al., filed Apr. 16, 2004 (Attorney Docket No. X-0148), the contents of which are incorporated herein by reference.

A reforming reactor suitable for use in the apparatus of the present invention can be operated in a reforming mode to produce a hydrogen-rich reformate, or in one or more non-reforming modes. “Non-reforming modes” of operation should not be construed to include indefinite periods of time while the reactor is inoperable, but is intended to refer to those periods when the reactor is operational, although not generating a hydrogen-rich reformate that meets specification. Examples of non-reforming modes of operation include but are not limited to the heating of the catalyst bed to a reforming temperature, heating of the catalyst bed to a calcination temperature, cooling of the catalyst bed to a reforming temperature, hydrating of the catalyst bed with steam, adjusting a flow of hydrocarbon fuel to the catalyst bed and adjusting a flow of steam to the catalyst bed. During periods in which the reactor is operating in a non-reforming mode, the controller directs stored reformate from the hydrogen storage device so as to provide a continuous supply of hydrogen-rich reformate to the reformate outlet.

A frequently occurring non-reforming mode of operation can include the heating of the carbon dioxide fixing material to a high temperature at which fixed carbon dioxide is released. As used herein, the term “calcine” and its derivatives are intended to refer to those reactions or processes wherein a carbon dioxide fixing material is heated to a temperature at which fixed carbon dioxide is released due to thermal decomposition, phase transition or some other physical or chemical mechanism. A temperature or range of temperatures at which fixed carbon dioxide is released is referred to as a “calcination temperature”. In a preferred embodiment, the calcination temperature for the carbon dioxide fixing material will be above the selected reforming reaction temperature. More specifically, the calcination temperature of the fixing material will be above about 550° C., preferably above about 650° C., and more preferably above about 750° C. Although not to be construed as limiting of suitable carbon dioxide fixing materials, a preferred calcination reaction has the equation:
CaCO₃→CO₂+CaO (calcination) (V).

The carbon dioxide fixing material can be heated to a calcination temperature by flowing heated gas(es) through the bed under conditions at which fixed carbon dioxide is released. Such gases can include heated streams of helium, nitrogen, steam and mixtures of the same, as well as heated exhaust gases from a fuel cell or the tail gas of a metal hydride storage system. In addition, heat exchanging and heat generating means such as are described herein can be used to heat the carbon dioxide fixing material to a calcination temperature. In some embodiments, the carbon dioxide fixing material can be heated to a calcination temperature by heated oxidation products that are produced by an oxidation reaction within the reactor. In such an embodiment, hydrocarbon fuel and oxidant are mixed and oxidized either catalytically or non-catalytically within the reactor. In a preferred embodiment, an oxidation zone is disposed within the reactor separate from the catalyst bed so that carbon or other oxidation by-products are not deposited within the catalyst bed. Optionally, a heat transfer device can be used to facilitate the transfer of heat between the catalyst bed and the oxidation zone, particularly when the oxidation zone is disposed downstream of the catalyst bed or external to the reactor vessel. The temperature of the oxidation reaction and the heated oxidation products can be adjusted by adjusting the fuel and oxidant feed streams and/or by directing a temperature moderator into the reactor. Suitable temperature moderators can include a fluid material selected from the group consisting of steam, water, air, oxygen-depleted air, carbon dioxide, nitrogen or mixtures of the same. Reactors and methods that utilize heated oxidation products to calcinate a carbon dioxide fixing material are described in greater detail in U.S. patent application Publication No. 2002/0085967 A1, published Jul. 4, 2002 by Yokata; U.S. patent application Publication No. 2003/0150163 A1, published Aug. 14, 2003 by Murata, et al.; and U.S. patent application “Reactor and Apparatus for Hydrogen Generation”, by Stevens, et al., Attorney Docket No. X-0186, filed Apr. 19, 2004, the disclosures of each of which is incorporated herein by reference.

Regardless of the means by which the carbon dioxide fixing materials is heated to a calcination temperature, a volume of steam and/or nitrogen can optionally be passed through the bed as a sweep stream for removing released carbon dioxide from the bed.

Another non-reforming mode of operation occurs when the carbon dioxide fixing material is hydrated with steam. Repeated reforming/calcination cycles tend to decrease the fixing capacity of the carbon dioxide fixing materials resulting in a reduction of the hydrocarbon to hydrogen conversion rates. In an effort to minimize losses in carbon dioxide fixing capacity, it has been found that hydration of the carbon dioxide fixing material between one or more cycles can to an extent restore and sustain the fixing capacity of such materials at acceptable levels. In addition, it has been found that such hydration improves the reaction efficiencies for both the conversion rate of hydrocarbon fuel to hydrogen and the shift conversion of carbon monoxide to hydrogen and carbon dioxide.

Hydration of the calcinated carbon dioxide fixing material can occur at virtually any time, including but not limited to, after each calcination step, during reactor start-up and/or shut-down procedures, after the performance of a number of reforming/calcination cycles or can be triggered by detecting an undesirable change in reformate composition. By way of example, hydration can be triggered when the level of a monitored reformate component exceeds or falls below a predetermined level that is indicative of when the fixing capacity of the carbon dioxide fixing material has been impaired. Reformate components that can be monitored for this purpose include, but are not limited to, hydrogen, carbon monoxide, carbon dioxide, and unreacted hydrocarbon fuel.

Hydration can be achieved by contacting calcinated carbon dioxide fixing material with water, preferably in the form of steam. After calcination, the catalyst bed is at an elevated temperature relative to the reforming temperature. Hydration is preferably conducted at a hydration temperature that is below the calcination temperature, and more preferably, below the reforming temperature. Specifically, the hydration temperature should be less than 600° C., preferably below about 500° C., more preferably below about 400° C. and even more preferably below about 300° C. For instance, sufficient hydration can be achieved by passing steam at 200° C. through the catalyst bed.

Not to be bound by theory, but in embodiments where the carbon dioxide fixing material is calcium oxide, repeated cycles of fixing/calcinating carbon dioxide tends to compact the calcium oxide and form crystalline-like structures. Through hydration, at least a portion of the calcium oxide is converted with steam to calcium hydroxide. The formation of calcium hydroxide within the catalyst bed tends to break up and disrupt the compacted and crystalline-like structures and thereby increase the surface area of calcium oxide available for carbon dioxide fixing in subsequent cycles.

The amount of steam that is needed to achieve sufficient hydration will vary depending on the volume of the catalyst bed, the surface area of the carbon dioxide fixing materials within the bed, the type of fixing material used, the structure or matrix of catalyst(s) and fixing materials within the bed and the flow rate of steam through the bed. Where the fixing material comprises calcium oxide, sufficient steam should be passed through the catalyst bed to convert at least about 10% of the calcium oxide to calcium hydroxide to achieve the desired effect. More specifically, at least about 0.03 kg of steam per kg of calcium oxide is needed to achieve sufficient hydration. Greater quantities of steam may be needed where flow rates are higher. A more detailed description of the hydration of carbon dioxide fixing materials may be found in U.S. patent application entitled “Reforming With Hydration Of Carbon Dioxide Fixing Material”, by Stevens et al., filed on Apr. 19, 2004 (Attorney Docket No. X-0137), the description of which is incorporated herein by reference.

It is envisioned that the reactors suitable for use in the fuel supply apparatus of the instant invention can have a plurality of catalyst beds so that at least one bed is producing a hydrogen-rich reformate while other beds are in non-reforming mode(s). In such embodiments, a stored reformate is provided to a reformate outlet from a hydrogen storage device when each of the catalyst beds is operated in a non-reforming mode. However, in a preferred embodiment, the fuel supply apparatus has a single catalyst bed that cycles between reforming and non-reforming modes and the hydrogen storage device supplies stored reformate to the reformate outlet when the catalyst bed is operated in a non-reforming mode.

A fuel supply apparatus of the instant invention will further comprise a hydrogen storage device in fluid communication with the reforming reactor for storing a portion of the reformate. The hydrogen storage device can be selected from hydrogen storage devices that are known in the art. Preferably, the hydrogen storage device will comprise a storage vessel that is suitable for containing the reformate in a desired form, including but not limited to, a high pressure gas, liquefied gas or solid. Suitable storage vessels can be portable, modular, skid mounted or fixed in place. Further, the storage vessel preferably has a storage capacity that will enable the hydrogen storage device to deliver stored reformate to the reformate outlet at a selected rate during periods in which the reforming reactor/catalyst bed is operated in a non-reforming mode. As a result, the capacity of the storage vessel will in part depend on the duration of time that the reactor/catalyst bed is in a non-reforming mode and the rate at which reformate is to be delivered to the reformate outlet during that period. Because the duration of operation in non-reforming mode(s) will vary, appropriate allowances in storage capacity should be made. In addition, it is envisioned that there may be periods of peak demand during which the hydrogen-rich reformate produced by the reforming reactor will need to be supplemented with stored reformate such that the determination of the capacity of the storage vessel should account for periods of high reformate demand as well. Although it might be desirable for the storage vessel to have sufficient storage capacity to deliver reformate to the reformate outlet at a desired rate during indefinite periods when the reforming reactor is not in operation, given the limitations of current hydrogen storage technology, such a storage capacity is not believed to be practical.

As noted above, the hydrogen storage device may store reformate in a number of different forms. By way of example, the hydrogen storage device may comprise a compressor and a high pressure storage vessel operably connected in fluid communication with the compressor for storing a high pressure reformate. Detailed descriptions of hydrogen compression storage systems may be found in U.S. Pat. No. 6,685,821 B2 issued Feb. 3, 2004 to Kosek, et al., and U.S. patent application Publication No. US 2003/0175564 Al published Sep. 18, 2003 by Mitlitsky, et al. High pressure hydrogen storage vessels also typically utilize hydrogen fixing materials as are described below. Compression systems utilizing such fixing materials are described in additional detail in U.S. Pat. No. 4,598,836 issued Jul. 8, 1986 to Wessel and U.S. Pat. No. 6,432,176 B1 issued Aug. 13, 2002 to Klos et al. The disclosure of each of these patent references is incorporated herein by reference.

Other suitable hydrogen storage device can comprise a storage vessel and a hydrogen fixing material disposed within the storage vessel for storing hydrogen at a various temperatures and pressures. Hydrogen fixing materials for use in such devices can include materials that will reversibly fix hydrogen, including but not limited to, activated carbon, carbon composites, fullerene-based materials, metal hydrides and the like. Descriptions of suitable hydrogen fixing materials for storing hydrogen may be found in U.S. Pat. No. 5,614,460 issued Mar. 25, 1997 to Schwartz, et al. (describing a method for producing microporous carbon materials); U.S. Pat. No. 5,653,951 issued Aug. 5, 1995 to Rodriguez, et al. (describing the use of layered carbon nanostructures in the form of nanotubes, nanofibrils, nanoshells and nanofibres); U.S. Pat. No. 6,290,753 B1 issued Sep. 18, 2001 to Maeland, et al. (describing the use of carbon materials having turbostratic microstructures); U.S. Pat. No. 6,596,055 B2 issued Jul. 22, 20003 to Cooper, et al. (describing the use of carbon-metal hybrid materials); U.S. Pat. No. 6,113,673 issued Sep. 5, 2000 to Loutfy, et al. (describing the use of fullerene-based materials); U.S. Pat. No. 6,165,643 issued Dec. 26, 2000 to Doyle, et al. (describing a fixing material comprising a metal hydride and an interface activation composition comprising one or more platinum group metals); U.S. Pat. No. 5,360,461 issued Nov. 1, 1994 to Meinzer, (describing the use of metal hydrides imbedded in a polymeric material); U.S. Pat. No. 6,471,935 B2 issued Oct. 29, 2002 to Jensen, et al. (describing the use of aluminum hydride compounds); U.S. Pat. No. 6,534,033 B1 issued Mar. 18, 2003 to Amendola, et al. (describing the use of borohydride based solutions); U.S. Pat. No. 6,616,891 B1 issued Sep. 9, 2003 to Sapru, et al. (describing the use alloys of titanium, vanadium, chromium and manganese, with or without additional elements); U.S. Pat. No. 6,672,372 B1 issued Jan. 6, 2004 to Li, et al. (describing the use of magnetic hydrogen-absorbing material); and U.S. Pat. No. 6,672,077 B1 issued Jan. 6, 2004 to Bradley, et al. (describing use of nanostructures formed from light elements selected from the second and third rows of the periodic table). The disclosure of each of these references is incorporated herein by reference.

In still other embodiments, the hydrogen storage device can comprise a liquefaction unit capable of converting the hydrogen-rich reformate to a liquefied reformate. In such embodiments, a storage vessel will be operably connected in fluid communication with the liquefaction unit that is suitable for containing a liquefied reformate. By way of example, U.S. Pat. No. 6,591,617 B2 issued Jul. 15, 2003 to Wolfe, describes the liquefaction of hydrogen gas using cryogenic cooling and the storage of the liquefied gas in reusable canister tanks that can be distributed to an end user. The disclosure of this patent is incorporated herein by reference.

The fuel supply apparatus of the instant invention will also include a reformate outlet in fluid communication with the hydrogen storage device at which a hydrogen-rich reformate is delivered and made available for storage or use in a hydrogen consuming device or process. In some embodiments, the reformate outlet will be a feature of the hydrogen storage device. In others, an intermediate conduit will deliver reformate to a reformate outlet that is remote from the hydrogen storage device. For instance, it is envisioned that the fuel supply apparatus of the instant invention or the hydrogen storage device may be at least partially enclosed and that the reformats outlet will be disposed on a wall of such an enclosure or outside such an enclosure. In embodiments where the reformate outlet is remote from the hydrogen storage device, it is preferred that the reformate outlet is in fluid communication with both the reforming reactor and the hydrogen storage device. In such embodiments, an optional manifold as described herein can be used to control the delivery of hydrogen-rich reformate and stored reformate to the reformate outlet.

The reformate outlet can also comprise means for connecting with an optional hydrogen-consuming device. Such connection means should provide a secure connection and fluid communication for hydrogen-rich reformate to be delivered through the reformate outlet to a hydrogen-consuming device. Such connections means can comprise a gas dispenser such as has been developed for the dispensing of hydrogen to vehicles having on-board hydrogen storage. A detailed description of such connections means may be had by reference to U.S. Pat. No. 6,630,648 B2 issued Oct. 7, 2003 to Gruenwald, U.S. patent application Publication No. US 2003/0175564 A1 published Sep. 18, 2003 by Mitlitsky, et al., and U.S. patent application Publication No. US 2003/0148153 A1 published Aug. 7, 2003 by Mitlitsky, et al., the disclosure of each of which is incorporated by reference.

Optionally, the reformate outlet can further comprise sensor(s) for monitoring the flow and/or composition of a hydrogen-rich reformate at the outlet. Alternatively, such sensors need not be incorporated into the structure of the reformate outlet, but can be disposed proximate to the outlet depending on the purpose and subject of the chosen sensor.

A fuel supply apparatus of the instant invention will further include a controller that is in communication with the reforming reactor and the hydrogen storage device. The controller is provided to monitor the operations of the reactor and the storage device and to control the delivery of reformate to the reformate outlet. In addition, the controller controls how hydrogen-rich reformate is distributed between the reformate outlet and the hydrogen storage device. Suitable controllers will comprise a processor and memory with stored routines as are well known in the art. An input-output interface located proximate or remote from the processor can also be included to enable the manual input of data and instruction by an operator. In the alternative, suitable controllers can include electronic controls for monitoring the operations of the reforming reactor/catalyst bed(s) and the hydrogen storage device

Preferably, the controller will be in communication with other elements of the fuel supply apparatus, such as the reformate outlet and optional elements such as heat generating means, polishing unit(s), manifold(s), valves, and any hydrogen-consuming device connected to the reformate outlet. In addition, the fuel supply apparatus can include sensor(s) in communication with the controller to provide data concerning reformate composition, flow rate, as well as temperature, and/or pressure signals at various locations within the apparatus.

In some embodiments, the controller can provide operational control over one or more elements of the fuel supply apparatus such as the reforming reactor, the hydrogen storage device, an optional manifold, and the reformate outlet. Such operational control enables the controller to control the mode of operation of the reforming reactor/catalyst bed(s) and to thereby to control the amount and quality of hydrogen-rich reformate that is produced as well as operation of the reactor/catalyst bed(s) in various non-reforming modes. Similarly, operational control enables the controller to control the flow of reformate into the hydrogen storage device, the amount of reformate that is maintained within the hydrogen storage device as stored reformate, and the amount, if any, of stored reformate that is delivered to the reformate outlet. In addition, such operation control enables the controller to control the rate at which a hydrogen-rich reformate and/or stored reformate is delivered to the reformate outlet.

The use of a controller simplifies the operation of the fuel supply apparatus and the delivery of a continuous supply of hydrogen-rich reformate to the reformate outlet. In an optional but highly preferred embodiment, the controller will control the reforming reactor/catalyst bed(s) and the hydrogen storage device to deliver reformate to the reformate outlet at a selected rate. The selection of such a rate may be determined by an operator of the apparatus by inputting a selection. In such an embodiment, the controller will be capable of receiving such inputs and operating the fuel supply apparatus to deliver the appropriate flow of hydrogen-rich reformate. In an alternative, the selected rate can be determined at least in part based upon a reformate requirement of a hydrogen-consuming device in communication with the controller. In such an embodiment, no operator input is required to communicate reformate requirement(s) or periodic changes in such requirements to the controller. It should be noted that although only the rate at which reformate is to be delivered has been discussed, those skilled in the art will recognize that similar reformate criteria such as one or more compositional specifications can be controlled in a like manner. For instance, where the hydrogen-consuming device is a fuel cell that cannot tolerate reformate containing carbon monoxide at greater than 50 ppm, such a reformate requirement can be input or communicated to the controller to assure that only reformate meeting such a specification is delivered to the reformate outlet.

As noted throughout, the instant invention provides a continuous supply of hydrogen-rich reformate to the reformate outlet by maintaining a volume of stored reformate for delivery to the reformate outlet when the reforming reactor is either in a non-reforming mode or is not producing sufficient reformate to meet current demand. In either case, the controller determines how the hydrogen-rich reformate that is produced in the reforming reactor/catalyst bed(s) is distributed between the hydrogen storage device and the reformate outlet and when a portion of the stored reformate is to be delivered to the reformate outlet to supplement or substitute for hydrogen-rich reformate produced by the reactor.

A fuel supply apparatus of the instant invention can optionally include one or more polishing units disposed downstream from the reforming reactor. As used herein, a polishing unit refers to a device that can further purify or remove impurities or otherwise upgrade the hydrogen-rich reformate. Examples of suitable polishing units include drying units, methanation reactors, selective oxidizers, pressure swing adsorption systems, temperature swing adsorption systems, membrane separation systems, and combinations of the same. When used, the polishing unit is preferably disposed downstream from the reforming reactor in fluid communication with the hydrogen storage device so that hydrogen-rich reformate is conditioned prior to storage or delivery to the reformate outlet. In some embodiments, the polishing unit is a methanation reactor for converting carbon oxides and hydrogen to methane. Because the level of carbon oxides in the hydrogen-rich reformate is particularly low, the amount of hydrogen that is required to convert the carbon oxides to methane is not considered to be significant. Further, methane can remain in the hydrogen-rich reformate stream without creating a deleterious effect on catalyst systems downstream. In other embodiments, the polishing unit comprises a drying unit for removing water from the hydrogen-rich reformats. In a preferred embodiment, the fuel supply apparatus comprises a methanation reactor and a drying unit disposed downstream of the methanation reactor.

The fuel supply apparatus can further comprise a purification bed comprising a hydrogen-fixing material for selectively removing or fixing hydrogen to produce fixed hydrogen within the bed and a hydrogen-depleted reformate that flows through and passes out of the bed. As the hydrogen fixing material becomes at least partially saturated with hydrogen, the flow of reformate can be diverted or interrupted and hydrogen released from the bed. The hydrogen fixing material is preferably a solid metal-hydride forming material and the bed can optionally further comprise an inert material having a high heat capacity. A more detailed description of such a purification bed and its operation can be found in U.S. patent application “Apparatus And Method For Hydrogen Generation” by Bavarian et al., filed Apr. 19, 2004 (Attorney Docket No. X-0170).

In some embodiments, an optional manifold can be disposed downstream from the reforming reactor that is in fluid communication with each of the reactor, the hydrogen storage device and the reformate outlet. Preferably, the manifold should be under the control of the controller so that reformate can easily be directed to and from the hydrogen storage device and/or to the reformate outlet depending on the mode of operation of the reforming reactor and the rate at which reformate is to be delivered to the reformate outlet.

The fuel supply apparatus can also optionally include a hydrogen-consuming device disposed downstream of the reformate outlet that is in fluid communication with that outlet. In such embodiments, it is preferred that the controller be in communication with the hydrogen-consuming device so that the reforming reactor and hydrogen storage device can be controlled to deliver reformate to the reformate outlet at a rate and quality appropriate to the hydrogen-consuming device. Hydrogen-consuming devices and processes are well known in the art and can vary from fuel cells and fuel cell stacks to industrial plants having chemical and petroleum refining operations.

The instant invention also provides a method for providing a continuous supply of hydrogen-rich reformate for use in a hydrogen-consuming device or process. The method includes the step of reforming a hydrocarbon fuel within a catalyst bed comprising a reforming catalyst and a carbon dioxide fixing material to produce a reformate product comprising hydrogen and carbon dioxide. As noted above, the carbon dioxide fixing material is disposed within the reforming catalyst bed so that at least a portion of the carbon dioxide in the reformate product is removed causing a shift in the reforming reaction equilibrium to produce a hydrogen-rich reformate.

The method further includes storing at least a portion of the hydrogen-rich reformate in a hydrogen storage device to provide a stored reformate and controlling the hydrogen-rich reformate and/or stored reformate delivered to a reformate outlet. For instance, when the catalyst bed is operated in a non-reforming mode and hydrogen-rich reformate meeting specification is not being produced, stored reformate is delivered to the reformate outlet in order to maintain the supply of hydrogen-rich reformate. The hydrogen-rich reformate and stored reformate can optionally be controlled so as to be delivered to the reformate outlet at a selected rate. The rate at which hydrogen-rich reformate and/or stored reformate is to be delivered to the reformate outlet can be selected at least in part based on a reformate requirement of a hydrogen-consuming device in fluid communication with the reformate outlet. When the catalyst bed produces hydrogen-rich reformate at rate less than the selected rate, stored reformate can be delivered to the reformate outlet to supplement or augment the supply of hydrogen-rich reformate.

The methods of the instant invention can optionally include one or more steps prior to reforming the hydrocarbon fuel. Specifically, the methods can further include the steps of heating the catalyst bed to a calcination temperature prior to reforming the hydrocarbon fuel to release fixed carbon dioxide that may reside in the bed. The heated bed is allowed to cool to a reforming temperature prior to reforming the hydrocarbon fuel. Alternatively, or in addition to, the heated catalyst bed can be hydrated with steam prior to reforming the hydrocarbon fuel. In methods where the catalyst bed is hydrated with steam, the catalyst bed can also be heated to a reforming temperature prior to reforming the hydrocarbon fuel.

The method can also optionally include a polishing step wherein one or more impurities is removed from the hydrogen-rich reformate The polishing step can be selected from the group consisting of water removal, methanation, selective oxidation, pressure swing adsorption, temperature swing adsorption, and membrane separation. It is also envisioned that one or more polishing steps can be used in combination to upgrade the hydrogen-rich reformate.

In an optional, but highly preferred embodiment, the methods of the instant invention further include the step of interrupting the reforming of the hydrocarbon fuel for the purpose of regenerating the catalyst bed. In such an embodiment, the interruption of the reforming of the hydrocarbon fuel can be achieved by reducing the flow of hydrocarbon fuel and/or steam to the catalyst bed to levels that will not sustain the reforming reaction. After interrupting the reforming reaction, the catalyst bed is optionally but preferably heated to a calcination temperature to release fixed carbon dioxide. Carbon dioxide released from the catalyst bed, in the form of a carbon dioxide-laden gas, can then be directed out of the catalyst bed to vent or preferably sequestration. The catalyst bed can then be allowed to cool to a reforming temperature prior to resuming the reforming of the hydrocarbon fuel. In an alternative embodiment, after the carbon dioxide-laden gas has been directed from the catalyst bed, the catalyst bed can be hydrated with steam prior to resuming the reforming of the hydrocarbon fuel. When the catalyst bed has been hydrated with steam, the method preferably further includes the step of heating the catalyst bed to a reforming temperature prior to resuming the reforming of the hydrocarbon fuel.

### DETAILED DESCRIPTION OF THE FIGURES

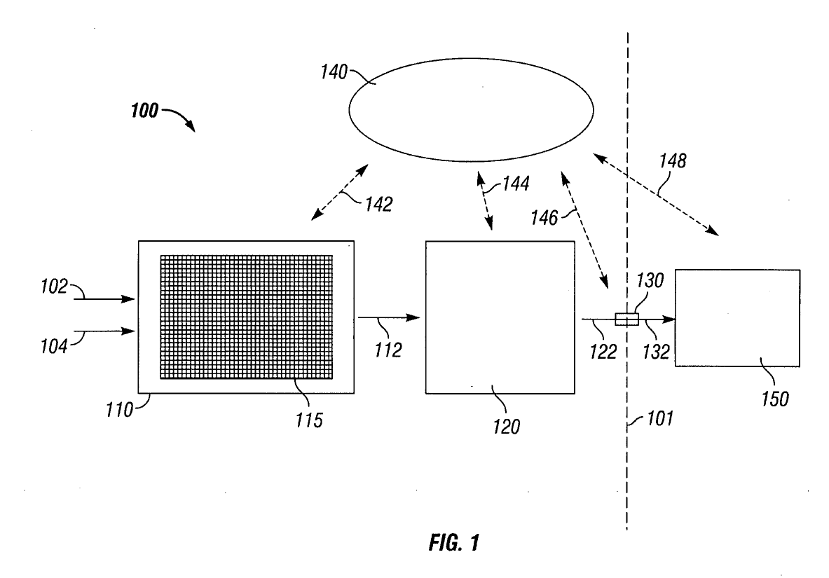

As illustrated in FIG. 1, fuel supply apparatus 100 includes a reforming reactor 110 containing single catalyst bed 115. As described in detail above, catalyst bed 115 includes a reforming catalyst and a carbon dioxide fixing material for converting a hydrocarbon fuel to a reformate. Preheated streams of hydrocarbon fuel 102 and steam 104 are directed into the reactor and catalyst bed. Reforming reactor 110 is in electronic communication with processor 140 as represented by broken line 142. Fluid communication between reforming reactor 110 and hydrogen storage device 120 is provided by conduit 112. Hydrogen storage device 120 is in fluid communication with reformate outlet 130 via conduit 122. Hydrogen-consuming device 150 is disposed downstream of and in fluid communication of the reformate outlet. Electronic communication between controller 140 and hydrogen storage device 120, reformate outlet 130 and hydrogen-consuming device 150 are shown by broken lines 144, 146 and 148 respectively. Broken line 101 illustrates an enclosure wall associated with the fuel supply apparatus.

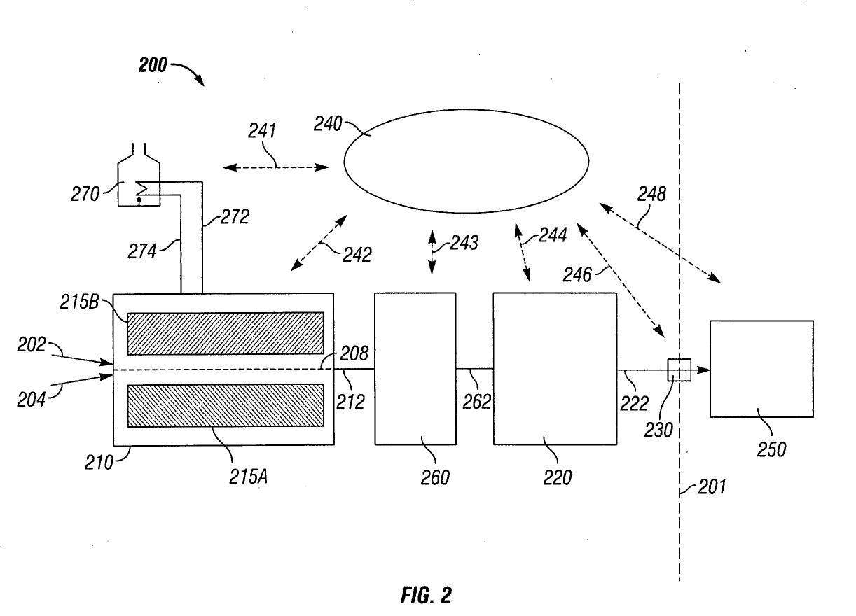

As illustrated in FIG. 2, fuel supply apparatus 200 includes a reforming reactor 210 containing a pair of catalyst beds 215A and 215B. Preheated streams of hydrocarbon fuel 202 and steam 204 are directed into the reactor and catalyst beds. As described in detail above, catalyst beds 215A and 215B include a reforming catalyst and a carbon dioxide fixing material for converting the hydrocarbon fuel to a reformate. Reforming reactor 210 has fluid controls for selectively directing the reforming reactants between isolated catalyst beds 215A and 215B so that the beds can be operated independently of one another. The isolated nature of the catalyst beds is shown only by broken line 208. Independent operation enables each bed to be operated in a different mode at any given time. More specifically, such independent operation enables one bed to be operated in a reforming mode to produce a hydrogen-rich reformate while the other bed is being operated in a non-reforming mode such as when fixed carbon dioxide is being released from the bed.

As illustrated, reforming reactor 210 is operably connected to external heater 270 for providing a heated fluid medium that can be directed to each of the catalyst beds through conduit 272 and returned through conduit 274. The heated fluid medium is directed to a heat exchanger or other heat transfer device embedded in each of the catalyst beds (not shown) for heating the catalyst beds. Although not shown in detail, fluid controls within reactor 210 enable the heated fluid medium to be selectively directed between the catalyst beds 215A and 215B to further enable their independent operation.

Fuel apparatus 200 also includes drying unit 260 disposed downstream from the reforming reactor 210 for removing water from the hydrogen-rich reformate prior to storage. Fluid communication between reforming reactor 210 and drier 260 is provided by conduit 212. Fluid communication between drying unit 260 and hydrogen storage device 220 is provided by conduit 262. Hydrogen storage device 220 is in fluid communication with reformate outlet 230 via conduit 222 and hydrogen-consuming device 250 is disposed downstream of and-in fluid communication of the reformate outlet. Electronic communication between controller 240 and heater 270, reforming reactor 210, drier 260, hydrogen storage device 220, reformate outlet 230 and hydrogen-consuming device 250 are shown by broken lines 241, 242, 243, 244, 246, and 248 respectively. Broken line 201 illustrates an enclosure wall associated with the fuel supply apparatus.

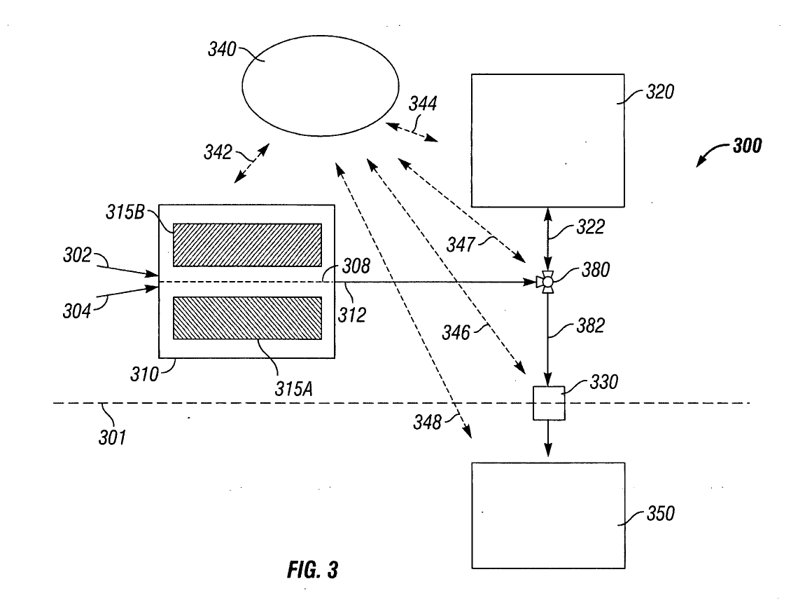

As illustrated in FIG. 3, fuel supply apparatus 300 includes a reforming reactor 310 containing a pair of catalyst beds 315A and 315B. Preheated streams of hydrocarbon fuel 302 and steam 304 are directed into the reactor and catalyst beds. As described in detail above, catalyst beds 315A and 315B include a reforming catalyst and a carbon dioxide fixing material for converting the hydrocarbon fuel to a reformate. Shown only by broken line 308, the catalyst beds within reforming reactor 310 will be isolated from one another and have fluid controls for selectively directing reforming reactants between the beds enabling independent operation of the beds.

Fluid communication between reforming reactor 310 and hydrogen storage device 320 is provided by conduits 312 and 322 and manifold 380. Hydrogen storage device 320 is in fluid communication with reformate outlet 330 via conduits 322 and 382 and manifold 380. Hydrogen-consuming device 350 is disposed downstream of and in fluid communication of reformate outlet 330. As illustrated, the flow of hydrogen-rich reformate from reforming reactor 310 to reformate outlet 330 and/or hydrogen storage device 320 is controlled by manifold 380. Furthermore, the flow of stored reformate from the hydrogen storage device to the reformate outlet is similarly controlled by manifold 380. Electronic communication between controller 340 and reforming reactor 310, hydrogen storage device 320, reformate outlet 330, manifold 380 and hydrogen-consuming device 350 are shown by broken lines 342, 344, 346, 347 and 348 respectively. Broken line 301 illustrates an enclosure wall associated with the fuel supply apparatus.

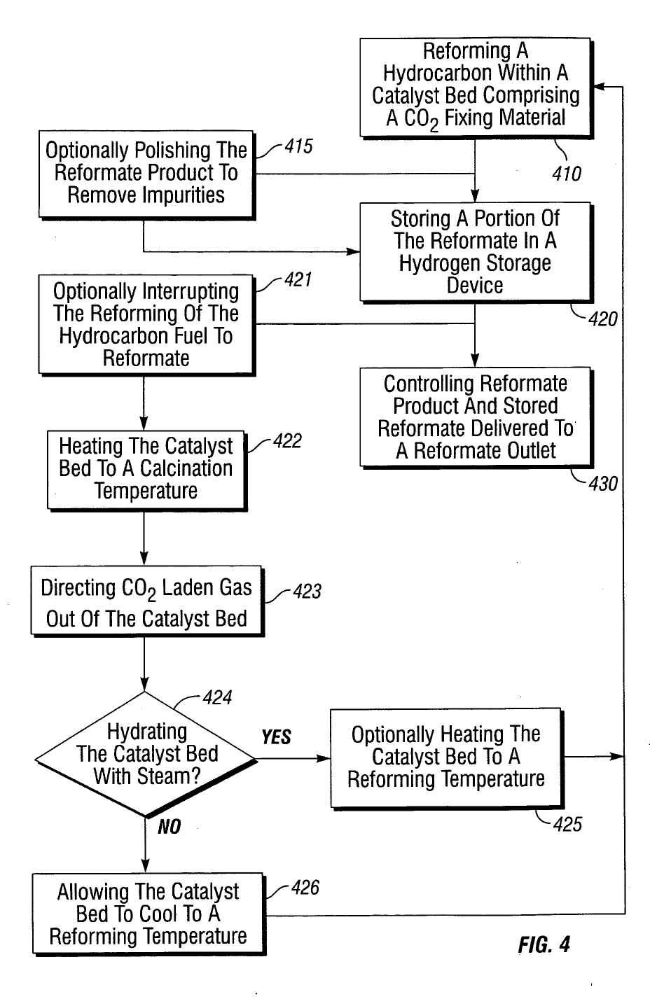

FIG. 4 is a flow diagram illustrating a method for providing a continuous supply of hydrogen-rich reformate for use in a hydrogen-consuming device or process. The method includes the step of reforming a hydrocarbon fuel within a catalyst bed comprising a reforming catalyst and a carbon dioxide fixing material (block 410) to produce a reformate product comprising hydrogen and carbon dioxide. The carbon dioxide fixing material within the catalyst bed fixes at least a portion of the carbon dioxide in the reformate product to yield a hydrogen-rich reformate and fixed carbon dioxide. The method includes storing at least a portion of the hydrogen-rich reformate in a hydrogen storage device (block 420) to provide a stored reformate and controlling the hydrogen-rich reformate and/or stored reformate delivered to a reformate outlet (block 430). Details concerning the reforming catalyst, optional water gas shift catalyst and carbon dioxide fixing material, as well as process details concerning the reactor feeds, their ratios, and reaction conditions are described herein.

Generally, the temperature of the catalyst bed is raised to a reforming reaction temperature with the flow of hydrocarbon fuel and steam adjusted to the appropriate flow rates and ratios. As the reforming reaction proceeds, at least a portion of the hydrogen-rich reformate is stored in the hydrogen storage device. When the reforming reactor is operated in reforming mode to produce hydrogen-rich reformate, the flows of hydrogen-rich reformate and stored reformate are controlled to deliver primarily hydrogen-rich reformate to the reformate outlet. During periods of peak demand, the flows of hydrogen-rich reformate and stored reformate are controlled so that the hydrogen-rich reformate is supplemented with stored reformate from the hydrogen storage device to maintain a desired supply of hydrogen-rich reformate to the reformate outlet. When the reforming reactor is operated in a non-reforming mode and is not producing hydrogen-rich reformate, stored reformate is flowed to the reformate outlet to maintain a continuous supply of hydrogen-rich reformate.

The illustrated method can further include a number of optional steps including polishing the hydrogen-rich reformate to remove impurities (block 415) and thereby further upgrade the reformate. In addition, fixed carbon dioxide will need to be removed from the catalyst bed. Removal of carbon dioxide from the bed can include the steps of interrupting the reforming of the hydrocarbon fuel (block 421), heating the catalyst bed to a calcination temperature (block 422) and directing the carbon dioxide-laden gas out of the catalyst bed (block 423). A sweep stream of steam and/or inert gases such as nitrogen can be directed through the bed to purge the bed prior to and/or following the calcination of the carbon dioxide fixing material.

In the process of resuming the reforming of the hydrocarbon fuel, the bed may optionally be hydrated with steam to restore and/or sustain the fixing capacity of the carbon dioxide fixing material (block 424). When the catalyst bed is hydrated with steam, the bed is rapidly cooled from the high calcination temperature. If the bed is cooled below the reforming temperature, the bed can optionally be heated to a reforming temperature before resuming the reforming of the hydrocarbon fuel (block 425). Where the catalyst bed is not hydrated with steam, the temperature of catalyst bed can be reduced (block 426) with the use of a heat exchange device or by passing a low temperature gas through the bed. As an alternative, the bed may be allowed to cool more passively through radiation cooling.

The removal of fixed carbon dioxide from the catalyst bed by interrupting the reforming reaction and heating the catalyst bed to a calcination temperature is a set of operations that is exemplary of when the reforming reactor/catalyst bed is operated in non-reforming mode. As described above, non-reforming modes can also include periods of reactor start-up, when adjusting feeds and/or reaction conditions to improve the hydrogen-rich reformate, and during shut-down procedures. During such periods of non-reforming operation, the reformate delivered to the reformate outlet is controlled to be primarily stored reformate from the hydrogen storage device.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A fuel supply apparatus for providing a continuous supply of a hydrogen-rich reformate, the fuel supply apparatus comprising:
a reforming reactor comprising a catalyst bed for converting a hydrocarbon fuel to a reformate, the catalyst bed comprising a reforming catalyst and a carbon dioxide fixing material;
a hydrogen storage device in fluid communication with the reforming reactor for storing a portion of the reformate;
a reformate outlet in fluid communication with the hydrogen storage device; and
a controller in communication with the reforming reactor and the hydrogen storage device for controlling the delivery of reformate to the reformate outlet.

2. The apparatus of claim 1, wherein the reforming reactor comprises a single catalyst bed.

3. The apparatus of claim 1, wherein the catalyst bed further comprises a water gas shift catalyst.

4. The apparatus of claim 1, wherein the reforming catalyst and the carbon dioxide fixing material have a non-uniform distribution within the catalyst bed.

5. The apparatus of claim 1, further comprising heat generating means operably connected to the reactor for heating the catalyst bed to a calcination temperature.

6. The apparatus of claim 1, further comprising a polishing unit disposed downstream from the catalyst bed for removing one or more impurities from the hydrogen-rich reformate, the polishing unit selected from the group consisting of drying units, methanation reactors, selective oxidation reactors, pressure swing absorption units, temperature swing absorption units, membrane separators and combinations of the same.

7. The apparatus of claim 1, wherein the hydrogen storage device comprises a compressor and high pressure storage vessel in communication with the compressor.

8. The apparatus of claim 1, wherein the hydrogen storage device comprises a storage vessel and a hydrogen fixing material disposed within the storage vessel.

9. The apparatus of claim 8, wherein the hydrogen fixing material comprises a material selected from the group consisting of activated carbon, carbon composites, fullerene based materials, metal hydrides, alloys comprising titanium, vanadium, chromium and manganese, and nanostructures formed from elements of the second and/or third rows of the periodic table.

10. The apparatus of claim 1, wherein the hydrogen storage device comprises a liquefaction unit for converting the hydrogen-rich reformate to a liquefied reformate and a storage vessel in communication with the liquefaction unit for storing the liquefied reformate.

11. The apparatus of claim 1, wherein the controller controls the operation reforming reactor and/or the hydrogen storage device.

12. The apparatus of claim 11, wherein the controller controls the delivery of reformate to the reformate at a selected rate.

13. The apparatus of claim 1, wherein the reforming reactor is operable in a non-reforming mode.

14. The apparatus of claim 13, wherein the hydrogen storage device has a storage capacity sufficient for delivering reformate to the reformate outlet at the selected rate when the reforming reactor is operated in the non-reforming mode.

15. The apparatus of claim 13, wherein the non-reforming mode comprises one or more operations selected from the group consisting of cooling the catalyst bed to a reforming temperature, heating the catalyst bed to a reforming temperature, heating the catalyst bed to a calcination temperature, hydrating the catalyst bed with steam, adjusting a flow of hydrocarbon fuel to the catalyst bed and adjusting a flow of steam to the catalyst bed.

16. The apparatus of claim 1, further comprising a hydrogen-consuming device in fluid communication with the reformate outlet, the hydrogen-consuming device disposed downstream of the reformate outlet.

17. The apparatus of claim 16, wherein the controller communicates with the hydrogen-consuming device.

18. The apparatus of claim 1, further comprising a manifold in fluid communication with each of the reforming reactor, the hydrogen storage device and the reformate outlet, the manifold disposed downstream of the reforming reactor for directing reformate to the hydrogen storage device and/or the reformate outlet.

19. The apparatus of claim 18, wherein the controller controls the operation of the manifold.

20. A method for providing a continuous supply of hydrogen-rich reformate for use in a hydrogen-consuming device or process, the method comprising the steps of:
reforming a hydrocarbon fuel within a catalyst bed comprising a reforming catalyst and a carbon dioxide fixing material to produce a reformate product comprising hydrogen and carbon dioxide, the carbon dioxide fixing material fixing at least a portion of the carbon dioxide to produce a hydrogen-rich reformate;
storing at least a portion of the hydrogen-rich reformate in a hydrogen storage device to provide a stored reformate; and
controlling the hydrogen-rich reformate and stored reformate delivered to a reformate outlet.

21. The method of claim 20, further comprising the step of heating the catalyst bed to a calcination temperature prior to reforming the hydrocarbon fuel.

22. The method of claim 21, wherein the heated catalyst bed is allowed to cool to a reforming temperature prior to reforming the hydrocarbon fuel.

23. The method of claim 21, wherein the heated catalyst bed is hydrated with steam prior to reforming the hydrocarbon fuel.

24. The method of claim 20, further comprising the step of heating the catalyst bed to a reforming temperature prior to reforming the hydrocarbon fuel.

25. The method of claim 20, further comprising the step of polishing the reformate product to remove one or more impurities, the polishing step selected from the group consisting of water removal, methanation, selective oxidation, pressure swing adsorption, temperature swing adsorption, membrane separation and combinations of the same.

26. The method of claim 20, further comprising the step of interrupting the reforming of the hydrocarbon fuel in the catalyst bed.

27. The method of claim 26, wherein the reforming of the hydrocarbon fuel is interrupted by reducing a flow of hydrocarbon fuel to the catalyst bed.

28. The method of claim 26, further comprising the step of heating the catalyst bed to a calcination temperature to release fixed carbon dioxide and form carbon dioxide-laden gas.

29. The method of claim 28, further comprising the step of directing the carbon dioxide-laden gas out of the catalyst bed.

30. The method of claim 29, further comprising the steps of
allowing the catalyst bed to cool to a reforming temperature; and
resuming the reforming of the hydrocarbon fuel.

31. The method of claim 29, further comprising the steps of
hydrating the catalyst bed with steam; and
resuming the reforming of the hydrocarbon fuel.

32. The method of claim 31, further comprising the step of heating the catalyst bed to a reforming temperature prior to resuming the reforming of the hydrocarbon fuel.

33. The method of claim 20, further comprising the step of selecting a rate at which hydrogen-rich reformate and/or stored reformate is to be delivered to the reformate outlet.

34. The method of claim 33, wherein the rate at which hydrogen-rich reformate and/or stored reformate is to be delivered to the reformate outlet is selected at least in part on a reformate requirement of a hydrogen-consuming device in fluid communication with the reformate outlet.

35. The method of claim 20, wherein stored reformate is delivered to the reformate outlet when the catalyst bed is operated in a non-reforming mode.

36. The method of claim 20, wherein the hydrogen-rich reformate and stored reformate are controlled to be delivered to the reformate outlet at a desired rate.

37. The method of claim 36, wherein stored reformate is delivered to the reformate outlet when the catalyst bed produces reformate product at rate less than the desired rate.
